(19) United States
(12) Patent Application Publication
(10) Pub. No.: US 2011/0299598 A1
(43) Pub. Date: Dec. 8, 2011

(54) MOTION VECTOR DISPLAY CIRCUIT AND MOTION VECTOR DISPLAY METHOD

(75) Inventor: Isao SEZAKI, Kanagawa (JP)

(73) Assignee: Renesas Electronics Corporation, Kanagawa (JP)

(21) Appl. No.: 13/151,890

(22) Filed: Jun. 2, 2011

(30) Foreign Application Priority Data
Jun. 8, 2010 (JP) 2010-131369

(51) Int. Cl. H04N 7/26

(52) U.S. Cl. 375/240.16; 375/E07.125

(57) ABSTRACT

A motion vector display circuit includes a motion vector detection circuit that detects a motion vector between frame images, and a norm calculation circuit that calculates the length of a motion vector detected by the motion vector detection circuit. The length of the detected motion vector is converted into a luminance component of a display signal, a first component of the motion vector is converted into a first chrominance component of the display signal, a second component of the motion vector is converted into a second chrominance component of the display signal, and the motion vector is displayed using the display signal.

### TECHNICAL FIELD

This application is based upon and claims the benefit of the priority of Japanese patent application No. 2010-131369, filed on Jun. 8, 2010, the disclosure of which is incorporated herein in its entirety by reference thereto.

The present invention relates to a motion vector display circuit and motion vector display method, and particularly to a circuit displaying a motion vector used for generating an intermediate frame in frame rate conversion mounted on a television and a method for displaying a motion vector.

### BACKGROUND

When a moving image is displayed at a frame rate different from the original frame rate, the frame rate can be converted using two methods: a simple method repeatedly displaying the same image without using motion compensation and a method newly generating a motion-compensated intermediate frame. In the latter method, a motion vector representing the direction in which an image moves and the length of the motion is generated from the images of frames before and after a position for which an intermediate frame is generated, and an intermediate frame is generated according to the generated motion vector.

For instance, the frame rate for film is 24 frames per second. When this is displayed on a liquid crystal display television (LCD TV) of 60 frames per second using the former method, the motion of the images will not be smooth and look awkward since one frame is repeatedly displayed twice or three times. The current LCD TVs do not employ the former method that produces an awkward motion, but mostly employ the latter method generating intermediate frames. The images of adjacent frames on the time axis do not have much difference when they are compared to each other. When an intermediate frame is generated in the latter method, a part of the images of adjacent frames are sometimes used. However, a motion vector greatly influences the image quality of the intermediate frame since a motion vector generated by comparing adjacent frames determines several factors: the size of an image taken from the adjacent frames, from which coordinates of the adjacent frames the image is taken, and for which coordinates of an intermediate frame the image is used. Therefore, means for observing a motion vector is required when one adjusts and inspects the image quality of a set of imaging equipment while directly watching a color monitor of the equipment.

Next, a method disclosed in Patent Document 1 will be described as a conventional technology displaying a motion vector on a color monitor. As a conventional technology, FIG. 9 shows a television system conversion apparatus that performs motion interpolation processing using a motion vector. In FIG. 9, a digitized luminance signal 101 is supplied to a frame memory 102. The capacity of this frame memory 102 is used for converting the number of frames, and two or more frames are sufficient. A motion vector detection circuit 103 detects a motion vector by using signals temporally one frame away from each other from an output of the frame memory 102. Further, when the luminance signal 101 has been non-interlaced in advance, signals one field away from each other can be used. The screen of the luminance signal is divided into m×n blocks, and the motion vector detection circuit 103 detects a motion vector for each block. Regarding m×n, for instance, there is a method in which one block is eight pixels×eight lines. There are two kinds of detection methods: a block matching method that calculates the absolute values of signal differences between frames for each pixel within a block and finds a block having a smallest sum total of the absolute values among reference blocks prepared in advance, and a gradient method using image gradients and differences between frames. Either method can be used. Note that the block matching method is also known as the pattern matching method. A motion vector judgment circuit 104 determines whether or not the motion vector detected for each block matches the real motion. This judgment is performed by using a motion vector detected temporally before the current field or frame near the current block or a motion vector detected in a field or frame immediately before the current field or frame in the current block.

The other output of the frame memory 102 is supplied to a linear time axis interpolation circuit 106 and a motion compensation frame interpolation circuit 105. The linear time axis interpolation circuit 106 is time axis linear interpolation between frames used by a conventional television system conversion apparatus. The motion compensation frame interpolation circuit 105 performs time axis linear interpolation using a frame signal whose position is compensated by a motion vector and a frame interpolation ratio outputted from the motion vector judgment circuit 104. An interpolation selection circuit 107 selects the motion-compensated interpolation signal or the linear interpolation signal that is not motion-compensated according to appropriate selection criteria indicating which signal should be used. A luminance signal outputted from the interpolation selection circuit 107 is a signal obtained by converting the number of frames into an output system. Further, a line conversion circuit 108 converts the number of lines of this signal and performs line interpolation correcting an image distortion caused by the line conversion on the signal. An output of the line conversion circuit 108 is outputted as a final luminance signal 116.

A color signal (C signal) 111 is obtained by time-dividing digitized color-difference signals R-Y and B-Y. This signal system does not require its own motion vector detection circuit or motion vector judgment circuit and shares the motion vector detected from the luminance signal and judged. 113 denotes a motion vector selection circuit; 114 denotes a motion vector memory; and 115 denotes a C signal/motion vector switching circuit. The motion vector selection circuit 113 selects the output of the motion vector detection circuit 103 or the motion vector judgment circuit 104, and the selected output is written to the motion vector memory 114 that stores motion vector information of each block divided into m×n units on the selected side and capable of storing at least N lines. When information is read from the motion vector memory 114, the motion vector information of each block is converted into motion vector information for each scan line by address conversion while the motion vector information is read at the same timing as the final luminance signal 116. Further, the motion vector memory 114 is constituted by a memory unit that stores the motion vector information, and an address converter that generates a control signal for write/read memory access from an input/output reference signal, not shown in the drawing.

115 is a circuit switching between the motion vector and the original color signal system, and normally selects the color signal. When one wants to display a motion vector on a color monitor, the circuit selects the motion vector side and an output thereof is outputted as the final color signal 117 via the line conversion circuit 108.

As described above in detail, according to the conventional technology shown in FIG. 9, the length and direction of the detected motion vector are converted into the level and hue of the color signal, and the motion-compensated interpolation signal or the non-motion compensated linear interpolation signal is selected as the luminance signal.

According to the conventional technology shown in FIG. 9, when one adjusts or inspects the image quality of a set of imaging equipment while directly looking at a color monitor of the set, he is able to observe a motion vector by having the length and direction of the detected motion vector converted into the level and hue of a color signal and having changes of the motion vector displayed as changes in color on the color monitor. Meanwhile, in the conventional technology shown in FIG. 9, the motion vector-compensated interpolation signal or the non-motion compensated linear interpolation signal is selected as the luminance signal, and the motion vector cannot be directly observed in an image displayed on the color monitor.

The reason why one cannot directly observe a motion vector will be described below. The luminance signal is either time axis linear interpolation between frames without using a motion vector or time axis linear interpolation using a frame signal whose position is compensated by a motion vector and a frame interpolation ratio. Therefore, according to a motion vector, input images are synthesized with each other in the luminance signal and one is only able to observe the motion vector indirectly. For instance, when a black image moving quickly and a white image moving slowly in the same direction are compared, the white image moving slowly appears brighter than the black image moving quickly. Since the color signal level of an image with a large movement is high, the color saturation becomes high and the image is clearly visible, however, in the case of the black image moving quickly and the white image moving slowly, one has the illusion that the color signal level of the image moving slowly is higher than that of the image moving quickly since a white image is more visible than a black image regardless of color signal level. As a result, a user who adjusts and inspects a set of imaging equipment while directly watching a color monitor of the set has the illusion that an image with a small motion vector has a large motion vector.

### [Patent Document]

Japanese Patent Kokai Publication No. JP-A-1-309598

### SUMMARY

The entire disclosure of the above Patent Document is incorporated herein by reference thereto. The following analysis is given by the present invention.

According to the conventional technology described in Patent Document 1, when one adjusts or inspects the image quality of a set of imaging equipment while directly looking at a color monitor of the set, he is able to observe a motion vector by having the length and direction of the detected motion vector converted into the level and hue of a color signal, respectively, and having changes of the motion vector displayed as changes in color on the color monitor. However, in the conventional technology described in Patent Document 1, the luminance signal displayed on the color monitor is a signal selected from a motion vector-compensated interpolation signal and non-motion vector compensated linear interpolation signal and is not related to the length of the motion vector.

A problem of the conventional technology is that an observer who adjusts and inspects the equipment is unable to determine the length of the motion vector from an image displayed on the color monitor since the luminance signal displayed on the color monitor is not related to the length of the motion vector.

A motion vector display circuit according to a first aspect of the present invention comprises a motion vector detection circuit that detects a motion vector between frame images and a norm calculation circuit that calculates the length of a motion vector detected by the motion vector detection circuit; the length of the detected motion vector is converted into a luminance component of a display signal; a first component of the motion vector is converted into a first chrominance component of the display signal; a second component of the motion vector is converted into a second chrominance component of the display signal; and the motion vector is displayed using the display signal.

A motion vector display method according to a second aspect of the present invention includes detecting a motion vector between frame images; calculating the length of the motion vector; converting the length of the motion vector into a luminance component of a display signal; converting a first component of the motion vector into a first chrominance component of the display signal; converting a second component of the motion vector into a second chrominance component of the display signal; and displaying the display signal.

The meritorious effects of the present invention are summarized as follows.

According to the vector display circuit of the present invention, a motion vector display circuit matching the sense of an observer can be provided. The reason for this is that, since a detected motion vector is displayed by calculating the length of the motion vector, which then is converted into a luminance component of a display signal, it becomes possible to display the motion vector on a monitor in a way that matches the sense of the observer in terms of the length of the motion vector.

Further, according to the vector display method, a motion vector display method matching the sense of an observer can be provided. The reason for this is that it becomes possible to display the motion vector on a monitor in a way that matches the sense of the observer in terms of the length of the motion vector due to a step of detecting a motion vector, a step of calculating the length of the motion vector, and a step of displaying the length of the motion vector as a luminance component of a display signal.

### BRIEF DESCRIPTION OF THE DRAWINGS

FIG. 1 is a block diagram for explaining Example 1 of the present invention.

FIG. 2 is a block diagram for explaining Example 2 of the present invention.

FIG. 3 is a block diagram for explaining Example 3 of the present invention.

FIG. 4 is a flowchart illustrating a second exemplary embodiment of the present invention.

FIG. 5 is a flowchart illustrating Example 3 of the present invention.

FIG. 6 is a drawing for explaining Example 2 of the present invention.

FIGS. 7A, 7B, and 7C are display examples of frame images and a motion vector in the present invention.

FIGS. 8A and 8B are setting examples of level adjustment circuits in the present invention.

FIG. 9 is a block diagram illustrating the entire system of a conventional technology.

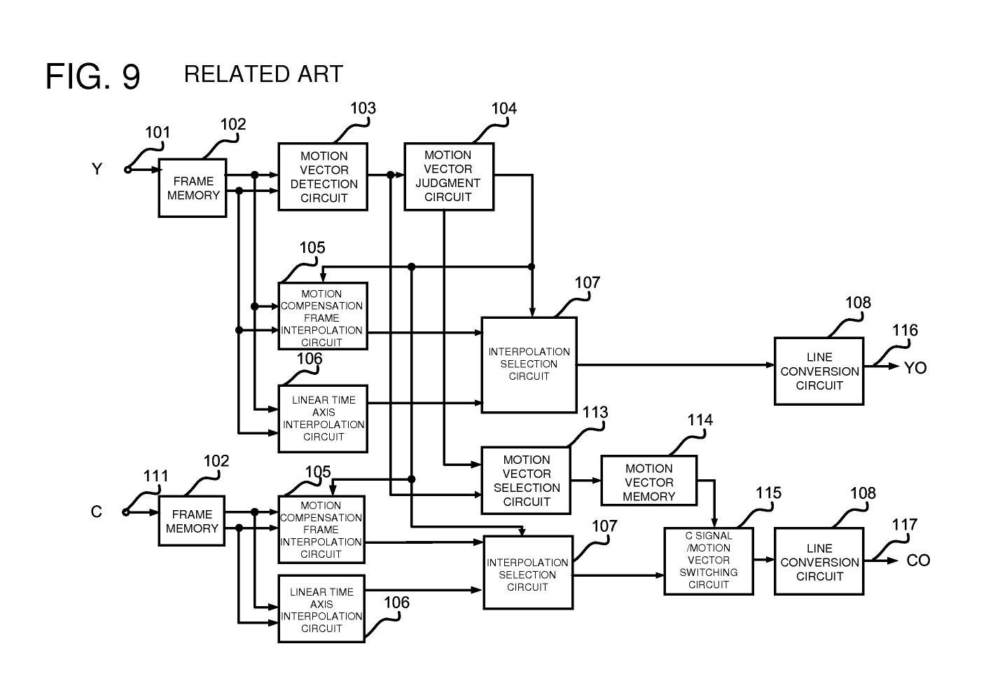

### PREFERRED MODES

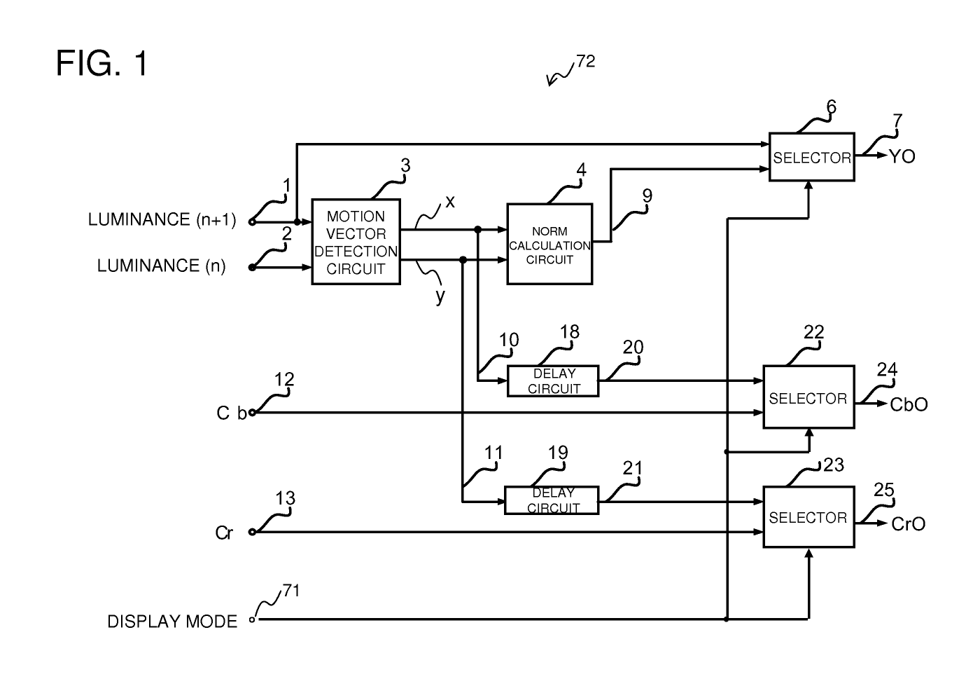

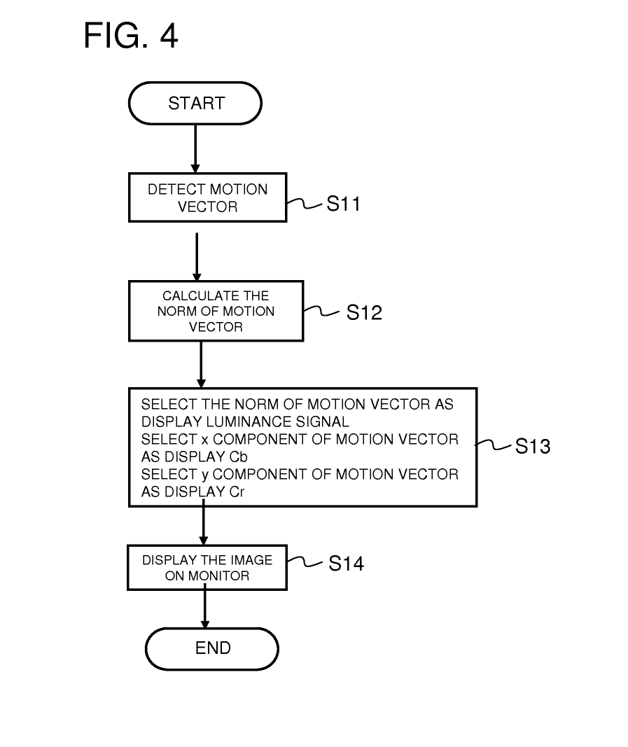

Exemplary embodiments of the present invention will be described with reference to the drawings as necessary. It should be noted that the drawings and symbols in the drawings referred to in the descriptions of the exemplary embodiments are presented as examples of exemplary embodiments and they do not limit variations of the exemplary embodiments of the present invention. The exemplary embodiments of the present invention will be described with reference to FIGS. 1 and 4 as necessary.

As shown in FIG. 1, a motion vector display circuit 72 of a first exemplary embodiment according to the present invention includes a motion vector detection circuit 3 that detects a motion vector between frame images, and a norm calculation circuit 4 that calculates the length of the motion vector detected by the motion vector detection circuit 3. The length of the detected motion vector is converted into a luminance component of a display signal, a first component of the motion vector is converted into a first chrominance component of the display signal, a second component of the motion vector is converted into a second chrominance component of the display signal, and the motion vector is displayed using the display signal. Here, the luminance component of the display signal correspond to a luminance signal output 7 in FIG. 1, the first component of the motion vector correspond to 10 in FIG. 1, the second component of the motion vector correspond to 11 in FIG. 1, the first chrominance component correspond to an output 24 of a color difference signal Cb in FIG. 1, and the second chrominance component correspond to an output 25 of a color difference signal Cr in FIG. 1, respectively.

In the first exemplary embodiment of the present invention, the motion vector detection circuit 3 detects a motion vector from a luminance (n), a luminance signal input of a previous frame, and a luminance (n+1), a luminance signal input of a current frame. Here, as a motion vector detection method, for instance, the block matching method is used. The motion vector calculated by the motion vector detection circuit 3 is a two-dimensional vector and is represented by the first component x and the second component y. The norm calculation circuit 4 calculates a norm NORM of the motion vector from the first component x and the second component y using Expression (1).

NORM=\sqrt{x²+y²} [Expression 1]

The NORM expressed in Expression (1) is the length of the motion vector. The motion vector display circuit 72 outputs the NORM calculated in Expression (1) as the luminance component YO of the display signal, the first component x as the first chrominance component CbO of the display signal, and the second component y as the second chrominance component CrO of the display signal, supplies the display signal to a color monitor, not shown in the drawing, and displays it on the monitor.

As shown in FIG. 4, a motion vector display method of a second exemplary embodiment according to the present invention includes step S11 of detecting a motion vector between frame images; step S12 of calculating the length of the motion vector; step S13 of converting the length of the motion vector into a luminance component of a display signal, a first component of the motion vector into a first chrominance component of the display signal, and a second component of the motion vector into a second chrominance component of the display signal; and step S14 of displaying the display signal.

Below, examples will be described in detail with reference to the drawings.

### Example 1

### Configuration of Example 1

FIG. 1 is a block diagram showing the motion vector display circuit 72 of Example 1 of the present invention. The motion vector display circuit 72 is constituted by the luminance signal input 1 of a current frame; the luminance signal input 2 of a previous frame; the motion vector detection circuit 3; the norm calculation circuit 4; a selector 6 and the luminance signal output 7; an output 9 of the norm calculation circuit 4; the first component x and the second component y of the motion vector outputted from the motion vector detection circuit 3; an input 12 of the color difference signal Cb of the current frame; an input 13 of the color difference signal Cr of the current frame; a delay circuit 18 that delays the output 10 of the motion vector detection circuit 3; a delay circuit 19 that delays the output 11 of the motion vector detection circuit 3; an output 20 of the delay circuit 18; an output 21 of the delay circuit 19; a selector 22; a selector 23; the output 24 of the color difference signal Common buffer; and the output 25 of the color difference signal Cr.

The selectors 6, 22, and 23 constitute a display signal selection unit. An upper user interface unit, not shown in the drawing, supplies a display mode 71 to the display signal selection unit, and the display signal selection unit selects a signal to be displayed based on the display mode 71.

### Operation of Example 1

With reference to FIG. 1, the operation of Example 1 will be described. An observer who observes the color monitor on which a frame image and a motion vector are displayed selects a display mode using the upper user interface unit. There are two display modes: a normal image display mode and a motion vector display mode, and when the normal image display mode is selected, a frame image is displayed as a display image, and when the motion vector display mode is selected, a motion vector is displayed as a display image. The selected display mode is supplied to the selectors 6, 22, and 23 constituting the display signal selection unit of the motion vector display circuit 72 as the display mode 71.

When the display mode 71 is the normal image display mode, the selector 6 selects the luminance signal input of the current frame as the luminance component YO of the display signal, the selector 22 selects the input of the color difference signal Cb of the current frame as the first chrominance component CbO of the display signal, and the selector 23 selects the input of the color difference signal Cr of the current frame as the second chrominance component CrO of the display signal. The selected YO, CbO, and CrO are displayed on the color monitor, and the observer observes the frame image.

Meanwhile, when the display mode 71 is the motion vector display mode, the selector 6 selects the output of the norm calculation circuit as the luminance component YO of the display signal, the selector 22 selects the output 20 of the delay circuit 18 as the first chrominance component CbO of the display signal, and the selector 23 selects the output 21 of the delay circuit 19 as the second chrominance component CrO of the display signal. Here, the delay circuits 18 and 19 are provided for compensating a timing shift caused by a delay occurring in the norm calculation circuit 4 so that the timings of the output 4 of the norm calculation circuit, the output 20 of the delay circuit 18, and the output 21 of the delay circuit 19 match. The first component x of the motion vector detected by the motion vector detection circuit 3 is supplied to the delay circuit 18, and the second component y of the motion vector detected by the motion vector detection circuit 3 is supplied to the delay circuit 19. Therefore, the first component x of the motion vector is selected as the first chrominance component CbO of the display signal, and the second component y of the motion vector is selected as the second chrominance component CrO of the display signal.

When the direction of the detected motion vector is θU and the hue angle of the display signal is θH, θU and θH can be expressed by Expressions (2) and (3), respectively.

θU=tan⁻¹(y/x) [Expression 2]

θH=tan⁻¹(CrO/CbO) [Expression 3]

As described above, since the display signal selection unit selects outputs so that CbO is x and CrO is y in the motion vector display mode, θH and θU become equal and the direction of the motion vector is represented by the hue of the display signal. Further, the luminance component YO of the display signal becomes the output NORM of the norm calculation circuit 4. Here, NORM is defined by Expression (1) and represents the length of the motion vector. As a result, the observer is able to evaluate the length of the motion vector with the luminance of an image displayed on the color monitor and the direction of the motion vector with the hue of the image displayed on the color monitor.

The motion vector display circuit of the present invention generates luminance expressing an image and two color difference signals only from a motion vector, and since the previous and current frames, which are the original sources for generating the motion vector, are not used, unnecessary information is not included and the motion vector can be displayed with high fidelity. Therefore, the present invention solves the problem of the conventional technology that an observer is unable to determine the length of a motion vector on an image displayed on a color monitor because the length of the motion vector is not related to changes in the brightness of the image displayed.

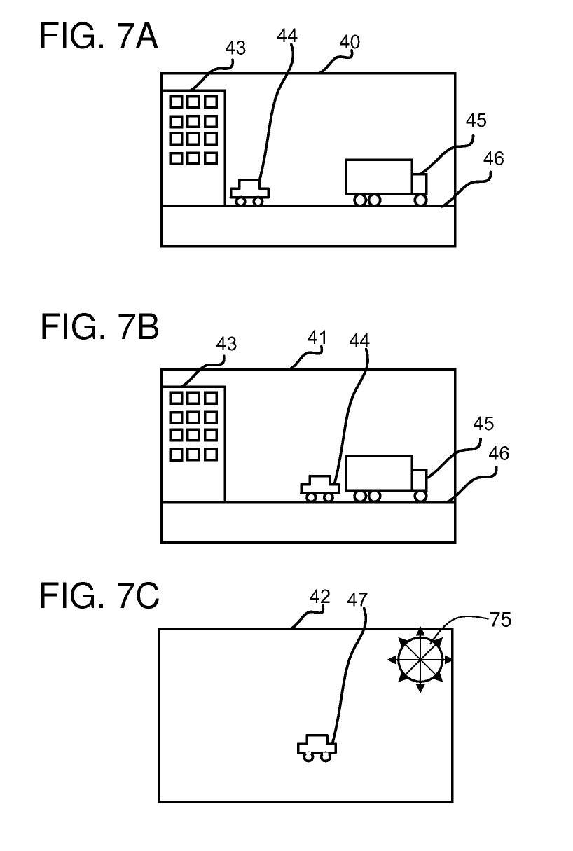

Next, a concrete example will be described using FIGS. 7A, 7B, and 7C. FIGS. 7A, 7B, and 7C are examples of images displayed on the color monitor of a display device to which the motion vector display circuit of Example 1 of the present invention shown in FIG. 1 is applied. FIG. 7A shows an image of a previous frame, FIG. 7B shows an image of a current frame, and FIG. 7C shows an image in which a motion vector is displayed. When an instruction by the user interface unit of the display device regarding the display mode indicates the normal image display mode, frame images are displayed on the color monitor as shown in FIGS. 7A and 7B. Meanwhile, an instruction by the user interface unit of the display device regarding the display mode indicates the motion vector display mode, a motion vector is displayed on the color monitor as shown in FIG. 7C.

The motion vector display circuit 72 generates a motion vector from the image 40 of the previous frame in FIG. 7A and the image 41 of the current frame in FIG. 7B. The image 40 of the previous frame in FIG. 7A and the image 41 of the current frame in FIG. 7B show a building 43, a car 44, a truck 45, and a road surface 46. The building 43, the truck 45, and the road surface 46 do not move and there is no difference between the image 40 of the previous frame in FIG. 7A and the image 41 of the current frame in FIG. 7B in terms of the building 43, the truck 45, and the road surface 46. In other words, the motion vectors of the building 43, the truck 45, and the road surface 46 are zero. The car 44 moves from left to right and has a motion vector. The image 42 displaying a motion vector in FIG. 7C is a display image obtained by supplying the image 40 of the (previous) frame in FIG. 7A and the image 41 of the current frame in FIG. 7B to the motion vector display circuit 72 of Example 1.

The image 42 in FIG. 7C only displays a car 47 having its motion vector displayed with the hue as the direction of the motion vector and the luminance as the length of the motion vector, and does not display the non-moving images. As a result, when one adjusts or inspects a set of imaging equipment while directly watching a color monitor, he is able to directly observe a motion vector on an image displayed on the color monitor. Further, the motion vector can be continuously displayed as a video, or it can be displayed as a still image, being stopped at a position with an image quality problem, for instance. Moreover, since the observer is able to alternately switch between and watch the motion vector and the corresponding frame images by switching the display modes using the user interface unit, he can efficiently proceed with image quality adjustment and inspection.

### Example 2

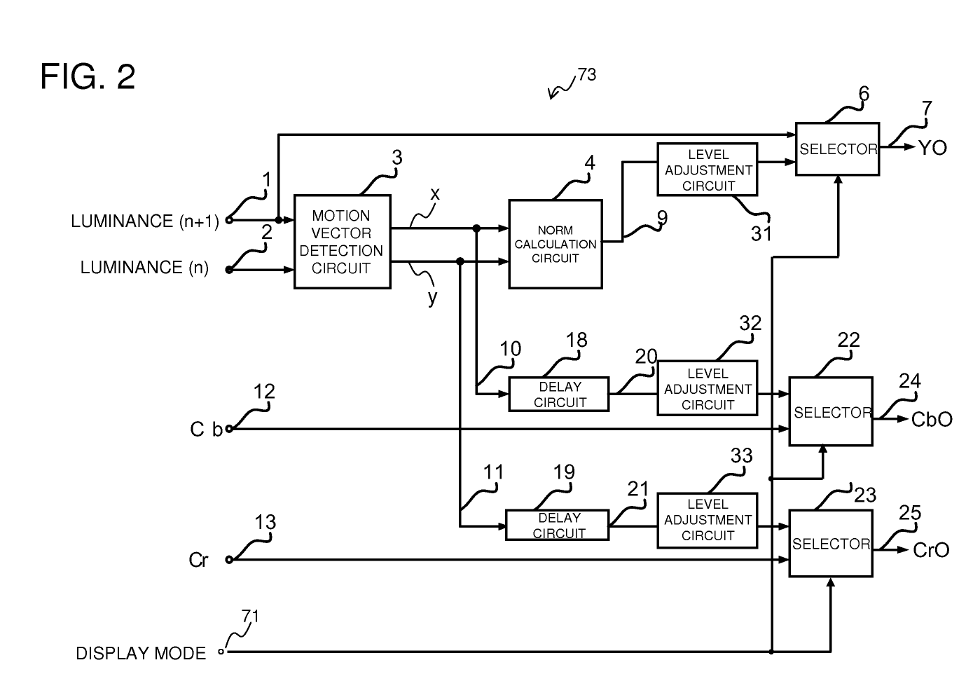

FIG. 2 is a block diagram of a motion vector display circuit 73 of Example 2 of the present invention. In Example 2, level adjustment circuits 31, 32, and 33 are added between the norm calculation circuit 4 and the selector 6, between the delay circuit 18 and selector 22, and between the delay circuit 19 and the selector 23 in Example 1, respectively.

The level adjustment circuit 31 has functions of shifting the level and increasing the gain of the output 9 of the norm calculation circuit 4, and of changing the output value to a predetermined value when it exceeds the predetermined value. The level adjustment circuit 32 has functions of shifting the level and increasing the gain of the output 20 of the delay circuit 18 that delays the output 10 of the motion vector detection circuit 3, and of changing the output value to a predetermined value when it exceeds the predetermined value. The level adjustment circuit 33 has functions of shifting the level and increasing the gain of the output 21 of the delay circuit 19 that delays the output 11 of the motion vector detection circuit 3, and of changing the output value to a predetermined value when it exceeds the predetermined value.

Even when it is difficult to observe the level of a motion vector on the color monitor because it changes very little, by having the level adjustment circuits 31, 32, and 33 in FIG. 2 shift the level of the motion vector to a discernable level, the visibility of the motion vector can be increased. For instance, in a case where a small airplane slowly moves from right to left and a background slowly moves from left to right in the opposite direction to the airplane, the motion vector is small since the movement is slow. It is difficult to distinguish the airplane from the background because the levels of the hue and the luminance of the airplane and the background are low and the motion vector appears dark overall. By shifting the levels using the level adjustment circuits, the differences in the hue and luminance levels between the airplane and the background can be increased, and the fact that the airplane and the background have different motion vectors can be confirmed.

Next, by providing the function of increasing the gain of a motion vector, the visibility of a motion vector can be increased when the change of the motion vector is minor. As in the case of the airplane and the background described above, the differences in the hue and luminance levels between the airplane and the background can be widened by increasing the gain, and the motion vector can be observed more easily.

Further, by providing the function of changing the level of a motion vector to a predetermined value when it exceeds the predetermined value, the level can be changed to a displayable level when it exceeds an upper limit by the level shifting function and the gain applying function.

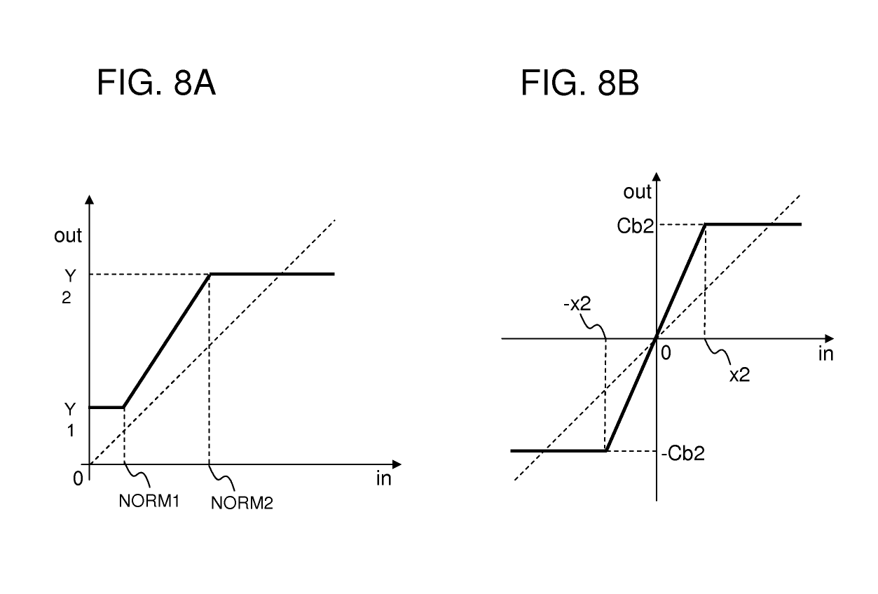

FIG. 8A shows a setting example of the level adjustment circuit 31, and FIG. 8B shows a setting example of the level adjustment circuit 32. A setting example of the level adjustment circuit 33 is the same as that of the level adjustment circuit 32; therefore the explanation is omitted. FIG. 8A shows a setting example in which the level shifting function, the gain applying function, and the function of changing the level to a predetermined value when it exceeds the predetermined value are used. Meanwhile, FIG. 8B shows a setting example in which the gain applying function and the function of changing the level to a predetermined value when it exceeds the predetermined value are used.

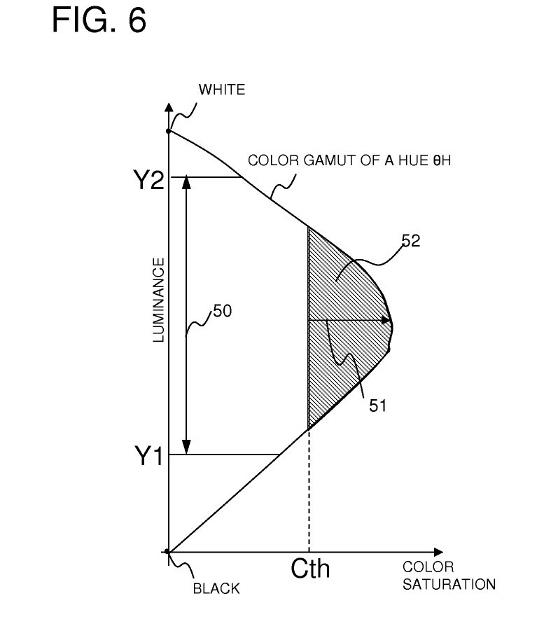

Next, FIG. 6 schematically shows the color gamut of a hue θH. Color saturation C on the horizontal axis is defined by Expression (4).

C=\sqrt{Cb²+Cr²} [EXPRESSION 4]

For instance, a range 50 of a luminance signal Y appropriate for evaluation by an observer is limited to an intermediate region such as Y1 to Y2. The reason for this is that it is difficult to observe changes in luminance in a low luminance region due to its darkness. Meanwhile, in a high luminance region, it is difficult to determine the hue because the color saturation is low. Further, it is preferable that a range 51 of the color saturation appropriate for evaluation by an observer be a region larger than a degree of color saturation Cth. This is because the observer can determine the hue more easily with a color having high color saturation. Therefore, a region of the color gamut appropriate for evaluation looks like a region 52 in FIG. 6, for instance. It should be noted that FIG. 6 schematically shows the color gamut and it is not an actual color gamut on the monitor.

In order to contain the length of a motion vector within the range between Y1 and Y2 in FIG. 6 and optimally display it, the level adjustment circuit 31 should be automatically set by analyzing histogram information as described below. First, a histogram relating to the norm of the motion vector is calculated, and a maximum value NORM_MAX and a minimum value NORM_MIN of the histogram are derived. When the influence of noise should be removed, a 99 percent point and a 1 percent point of the histogram should be used instead of the maximum and minimum values. Then, by setting the level adjustment circuit 31 to have characteristics in which NORM 1 and NORM2 in FIG. 8A are set to NORM_MIN and NORM_MAX, respectively, an image can be displayed on the color monitor while allocating the range of NORM_MIN and NORM_MAX to the range of Y1 and Y2, and a motion vector having optimum luminance can be displayed for an observer. Here, the histogram may be calculated from one frame or from a plurality of frame images in a video.

Since an inexperienced observer is not used to associate the direction of a motion vector with the hue, in order to compensate for this, a chart 75 showing the relation between the motion vector and the hue can be displayed on the screen of the color monitor in FIG. 7C. In this chart, on each point of a coordinate system having the x component and the y component of the motion vector as two axes, colors having corresponding luminance Y and chrominance Cr and Cb are displayed. The relations between the color chart and angles can be made clear by adding lines at 0, 45, 90, 135, 180, 225, 270, and 315 degrees. By using this chart, an inexperienced observer is able to proceed with image quality adjustment and inspection efficiently.

### Example 3

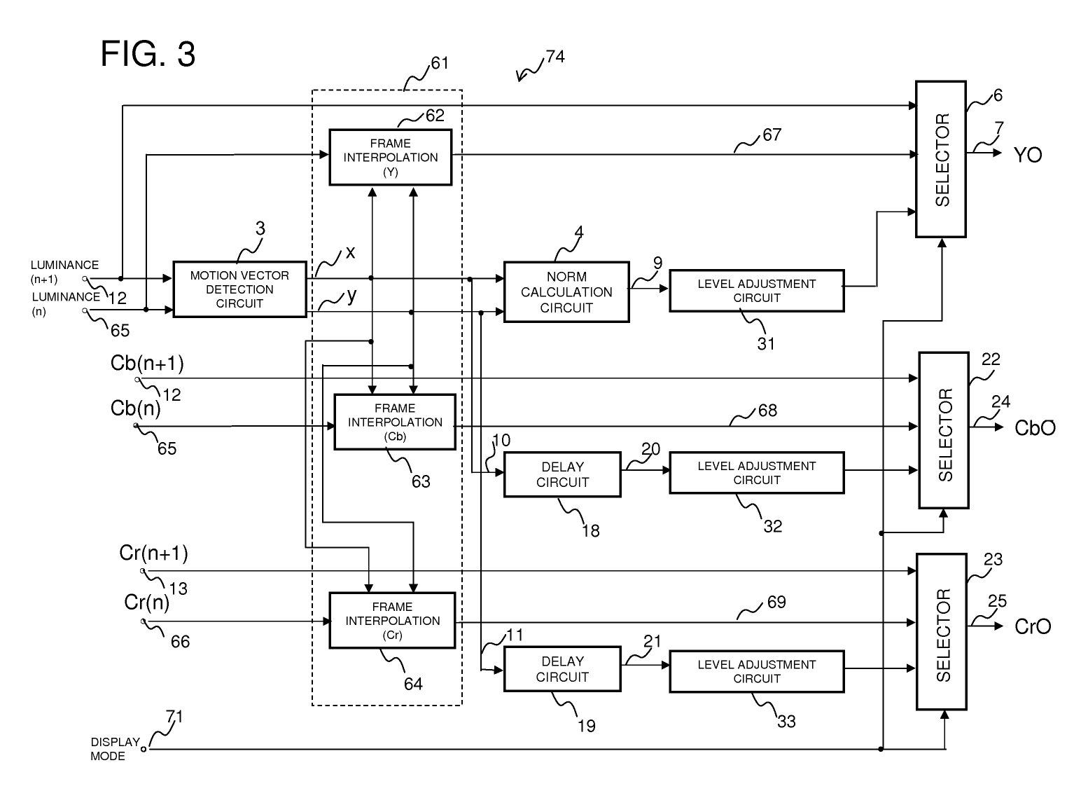

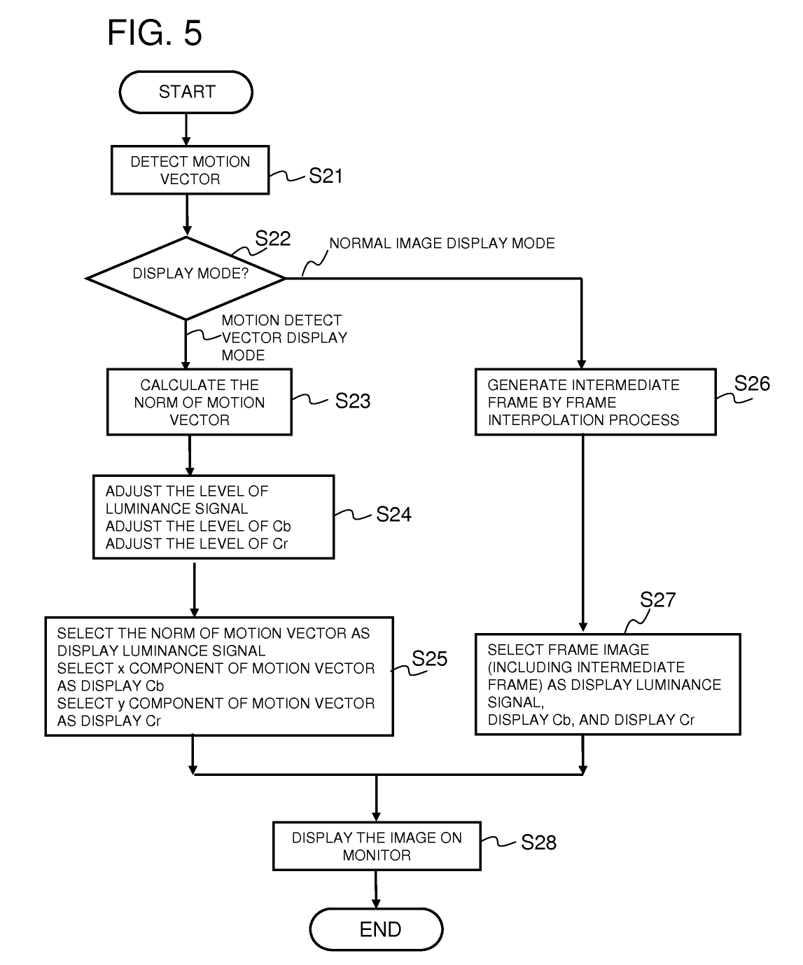

Example 3 will be described with reference to FIGS. 3 and 5. Example 3 is configured in such a manner that, when an intermediate frame is generated in frame rate conversion, it is possible to display a motion vector of the intermediate frame image and to adjust and inspect the image quality of the intermediate frame. FIG. 3 is a block diagram for explaining Example 3. A motion vector display circuit 74 in FIG. 3 has a frame interpolation generating circuit 61 added, compared to Example 2 in FIG. 2. The frame interpolation generating circuit 61 includes a frame interpolation circuit (Y) 62 for the luminance signal, a frame interpolation circuit (Cb) 63 for the color difference signal Cb, and a frame interpolation circuit (Cr) 64 for the color difference signal Cr.

Next, the operation of Example 3 will be described with reference to a flowchart in FIG. 5. First, in step S21, a motion vector is detected. In Example 3, a motion vector calculated by the motion vector detection circuit 3 in FIG. 3 or the motion vector calculated in the step S21 in FIG. 5 is a motion vector in an intermediate frame. Next, in step S22, whether the display mode is the normal image mode or the motion vector display mode is determined. Here, the display mode is selected by the upper user interface unit as in Examples 1 and 2. Next, in a case of the normal image display mode, an intermediate frame is generated by a frame interpolation process in step S26, and frame images including the intermediate frame is selected as the display luminance signal, the display Cb signal, and the display Cr signal in step S27. Meanwhile, in a case of the motion vector display mode, the norm of the motion vector is calculated in step S23, the levels of the luminance signal, Cb, and Cr are adjusted in step S24, and the norm of the motion vector, the x component of the motion vector, and the y component of the motion vector are selected as the display luminance signal, the display Cb signal, and the display Cr signal, respectively, in step S25. Finally, in step S28, an image is displayed on the monitor using the display signals selected in S27 in the case of the normal image mode, and the display signals selected in S25 in the case of the motion vector display mode.

Next, image quality adjustment an observer performs with a display device using the motion vector display circuit 3 of Example 3 will be described. First, the observer selects the normal image display mode with the user interface unit and observes a video after frame rate conversion, including an intermediate frame generated by the frame rate conversion. Further, in order to make sure whether the intermediate frame has been generated properly, he stops the video at the position of the intermediate frame where he wants to confirm the image quality, having a still image displayed. When the intermediate frame image is unsatisfactory, he switches to the motion vector display mode through the user interface unit, having the motion vector of the intermediate frame displayed on the monitor. Then, after analyzing the cause of the defect of the intermediate frame image by observing the length and direction of the motion vector of the intermediate frame in a region where the intermediate frame image is unsatisfactory, he adjusts the image quality of the intermediate frame image.

Next, an example of inspection an observer performs with a display device using the motion vector display circuit 3 of Example 3 will be described. As a test image from which a motion vector used for the inspection is detected, an image that entirely moves from left to right is used. If motion vector detection is performed accurately, the direction of the motion vector will indicate the same direction and a display image will have the same hue in the motion vector display mode. When a different hue is displayed in a region of the screen, it is determined that an error in the motion vector detection occurred for that region, the inspection has failed, and that the device has to be re-adjusted. As described, Example 3 can be applied for efficiently performing image quality adjustment and inspection of the motion vector of an intermediate frame generated by frame rate conversion.

The motion vector display circuit of the present invention can be applied to the image quality adjustment and inspection of a video processing apparatus capable of frame rate conversion.

It should be noted that other objects, features and aspects of the present invention will become apparent in the entire disclosure and that modifications may be done without departing the gist and scope of the present invention as disclosed herein and claimed as appended herewith. Also it should be noted that any combination of the disclosed and/or claimed elements, matters and/or items may fall under the modifications aforementioned.

What is claimed is:

1. A motion vector display circuit comprising:
a motion vector detection circuit that detects a motion vector between frame images; and
a norm calculation circuit that calculates the length of a motion vector detected by said motion vector detection circuit; wherein
the length of said detected motion vector is converted into a luminance component of a display signal;
a first component of said motion vector is converted into a first chrominance component of the display signal;
a second component of said motion vector is converted into a second chrominance component of the display signal; and
said motion vector is displayed using said display signal.

2. The motion vector display circuit as defined in claim 1 further comprising:
a display signal selection unit that switches between signals to be displayed according to either one of display modes: a normal image display mode or a motion vector display mode;
said display signal selection unit selecting said frame image as said display signal when said display mode is the normal image display mode; and
said display signal selection unit selecting the length of said motion vector, the first component of said motion vector, and the second component of said motion vector as the luminance component of the display signal, the first chrominance component of the display signal, and the second chrominance component of the display signal, respectively, when said display mode is the motion vector display mode.

3. The motion vector display circuit as defined in claim 2 further comprising a frame interpolation generating unit that generates an intermediate frame image from said frame images;
said motion vector detection circuit detecting a motion vector in an intermediate frame;
said frame interpolation generating unit generating said intermediate frame image from said frame images and the motion vector in said intermediate frame;
said display signal selection unit selecting said frame images and said intermediate frame image generated by said frame interpolation generating unit as said display signal when said display mode is the normal image display mode; and
said display signal selection unit selecting the length of the motion vector in said intermediate frame, the first component of the motion vector in said intermediate frame, and the second component of the motion vector in said intermediate frame as the luminance component of the display signal, the first chrominance component of the display signal, and the second chrominance component of the display signal, respectively, when said display mode is the motion vector display mode.

4. The motion vector display circuit as defined in claim 1 further comprising:
a first level adjustment circuit that adjusts an output level of said norm calculation circuit;
a second level adjustment circuit that adjusts a level of the first component of said motion vector; and
a third level adjustment circuit that adjusts a level of the second component of said motion vector.

5. A motion vector display method comprising:
detecting a motion vector between frame images;
calculating the length of said motion vector;
converting the length of said motion vector into a luminance component of a display signal, converting a first component of said motion vector into a first chrominance component of the display signal, converting a second component of said motion vector into a second chrominance component of the display signal; and
displaying said display signal.

6. The motion vector display method as defined in claim 5 further comprising:
determining a display mode: a normal image display mode or a motion vector display mode;
displaying said frame image when said display mode is the normal image display mode; and
calculating the length of a motion vector between said frame images; converting the length of said motion vector into a luminance signal of a display signal; converting a first component of said motion vector into a first chrominance component of the display signal; and converting a second component of said motion vector into a second chrominance component of the display signal when said display mode is the motion vector display mode.

7. The motion vector display method as defined in claim 6 further comprising:
detecting a motion vector in an intermediate frame;
frame-interpolating an intermediate frame image in said intermediate frame using said frame image and the motion vector in said intermediate frame;
displaying said frame image and said intermediate frame image when said normal image display mode is selected; and
converting the length of the motion vector in said intermediate frame into a luminance of a display signal; converting a first component of the motion vector in said intermediate frame into a first chrominance component of the display signal; and converting a second component of the motion vector in said intermediate frame into a second chrominance component of the display signal when said motion vector display mode is selected.

8. The motion vector display method as defined in claim 5 further comprising:
performing first level adjustment that adjusts an output level of said norm calculation circuit;
performing second level adjustment that adjusts a level of the first component of said motion vector; and
performing third level adjustment that adjusts a level of the second component of said motion vector.
